(19) United States
(12) Patent Application Publication
(10) Pub. No.: US 2017/0085770 A1
(43) Pub. Date: Mar. 23, 2017

(54) MOBILE TERMINAL PHOTOGRAPHING METHOD AND MOBILE TERMINAL

(71) Applicant: NUBIA TECHNOLOGY CO., LTD., Shenzhen, Guangdong (CN)

(72) Inventors: Xiaohui CUI, Shenzhen (CN); Qiang Wei, Shenzhen (CN)

(21) Appl. No.: 15/126,450

(22) PCT Filed: Aug. 30, 2014
(86) PCT No.: PCT/CN2014/085639

§ 371 Date: Sep. 15, 2016

(30) Foreign Application Priority Data
Mar. 24, 2014 (CN) 201410112654.3

(51) Int. Cl. H04N 5/235; H04N 5/232

(52) U.S. Cl. CPC H04N 5/2355; H04N 5/23293; H04N 5/23216

(57) ABSTRACT

A mobile terminal photographing method and a mobile terminal are disclosed in the present invention. The photographing method comprises the steps of: a camera collects one image every other preset period after starting photographing; and a synthesizing image is generated by performing image synthesis according to the brightness information of a current image and a previous image. A long time exposure is thereby simulated by the use of image synthesis technique, and the long time exposure is performed by continuously collecting image data of a captured object, a star orbit photographing function is thereby added to the mobile terminal, so that a user can take use of the mobile terminal for capturing the star moving orbit or for similar applicable scene according to the setting, and can preview the photographing effect at real time.

### TECHNICAL FIELD

The disclosure relates to the technical field of camera shooting, and in particular to a shooting method for a mobile terminal and the mobile terminal.

### BACKGROUND

Along with continuous improvement of camera shooting hardware of mobile terminals such as mobile phones and tablets, shooting functions of mobile terminals become more and more diversified and shooting requirements of users on mobile terminals also increase. A current shooting function of a mobile terminal is dependent on camera shooting hardware equipment and a related processing algorithm provided by a chip provider, and the mobile terminal only has fixed shooting modes of focusing, white balance and the like.

A professional camera shooting device such as a single lens reflex may implement long-time continuous exposure under support of photosensitive hardware, so that star trail shooting may be performed to shoot a motion trail of a star. During star trail shooting, exposure time of 20 to 60 minutes is usually required, while photosensitive hardware capable of supporting long-time exposure is expensive, so that it is impossible to equip a nonprofessional shooting device, such as a mobile terminal including a mobile phone, a tablet and the like, with such expensive photosensitive hardware. Therefore, existing mobile terminals do not have a star trail shooting function under limits of camera shooting hardware, and may not meet requirements of users on utilization of the mobile terminals for star trail shooting. In addition, when a professional camera shooting device is utilized for star trail shooting, a user may not preview a shooting result in real time.

### SUMMARY

The present disclosure is intended to provide a shooting method for a mobile terminal and the mobile terminal, so as to add a star trail shooting function to the mobile terminal to meet a diversified requirement of a user and improve user experiences.

In order to achieve the purpose, the disclosure discloses a shooting method for a mobile terminal, which may include the following steps that:

a camera acquires images at preset time intervals; and image synthesis is performed according to luminance information of a current image and luminance information of a previous image, and a synthetic image is generated.

In an embodiment, the step that image synthesis is performed according to the luminance information of the current image and the luminance information of the previous image may include that:

it is determined whether luminance of a pixel in the current image is higher than luminance of a pixel in the previous image at the same region; and

if YES, the pixel in the previous image is replaced with the pixel in the current image at the same region, and image synthesis is accordingly performed.

In an embodiment, after the step that the synthetic image is generated, the method may further include that: the synthetic image is displayed in real time.

In an embodiment, the camera may be a front camera, and after the step that the camera acquires the images at preset time intervals, the method may further include that:

mirroring processing is performed on the images.

In an embodiment, the camera may be a front camera, and after the step that the synthetic image is generated, the method may further include that: mirroring processing is performed on the synthetic image.

In an embodiment, before the step that the camera acquires the images at preset time intervals, the method may further include that:

upon reception of a shooting instruction, shooting is started after a preset time delay.

The disclosure further discloses a mobile terminal, which may include an image acquisition module and an image synthesis module, in which:

the image acquisition module may be configured to invoke a camera to acquire images at preset time intervals; and

the image synthesis module may be configured to perform image synthesis according to luminance information of a current image and luminance information of a previous image, and generate a synthetic image.

In an embodiment, the image synthesis module may be configured to:

determine whether luminance of a pixel in the current image is higher than luminance of a pixel in the previous image at the same region; and

if YES, replace the pixel in the previous image with the pixel in the current image at the same region, and accordingly perform image synthesis.

In an embodiment, the mobile terminal may further include a display module, and the display module may be configured to display the synthetic image in real time.

In an embodiment, the mobile terminal may further include a mirroring module, and the mirroring module may be configured to: determine whether the currently used camera is a front camera, and if YES, perform mirroring processing on the images.

In an embodiment, the mobile terminal may further include a mirroring module, and the mirroring module may be configured to: determine whether the currently used camera is a front camera, and if YES, perform mirroring processing on the synthetic image.

In embodiment, the mobile terminal may further include an anti-shake module, and the anti-shake module may be configured to: upon reception of a shooting instruction, transmit the shooting instruction to the image acquisition module after a preset time delay.

The disclosure further discloses a shooting method for a mobile terminal adopting the same concept, which may include the following steps that:

image data is acquired through a camera;

the image data is read at preset time intervals, and images are output; and

luminance information of the output images and luminance information of basic images are analysed and compared in real time, the output images and the basic images are synthesized according to analysis results, and synthetic images are generated,

herein a first output image may be a basic image of first image synthesis, and a newly generated synthetic image may be a basic image of next image synthesis.

In an embodiment, the step that the luminance information of the output images and the luminance information of the basic images are analysed and compared in real time, the output images and the basic images are synthesized according to the analysis results and the synthetic images are generated may include that:

it is determined whether luminance of a pixel in a current output image is higher than luminance of a pixel in a basic image at the same region; and

if YES, the pixel in the basic image is replaced with the pixel in the current output image at the same region, and image synthesis is accordingly performed.

In an embodiment, after the step that the synthetic images are generated, the method may further include that: the synthetic images are displayed in real time.

In an embodiment, the camera may be a front camera, and after the step that the image data is acquired through the camera, the method may further include that:

mirroring processing is performed on the acquired image data.

In an embodiment, before the step that the image data is acquired through the camera, the method may further include that:

upon reception of a shooting instruction, shooting is started after a preset time delay.

According to the shooting method for the mobile terminal provided by the disclosure, the images are acquired at preset time intervals, image synthesis is performed according to the luminance information of the current image and the luminance information of the previous image, and the synthetic image is generated, so that long-time exposure is simulated by adopting an image synthesis technology, the star trail shooting function is added to the mobile terminal, then the user may shoot a motion trail of a star or implement a similar application scene and preview a shooting effect in real time by virtue of the mobile terminal, the diversified requirement of the user is met, and the user experience is improved.

In addition, a bright point replacement manner is preferably adopted for image synthesis in the embodiment, and compared with a bright point superposing manner, has the advantages that the motion trail of the star may be shot more clearly and influence of other excessively bright points beside the trail of the star on a star trail effect is prevented.

The front camera of the mobile terminal may also be utilized for star trail shooting, mirroring processing is performed on the images to make the synthetic images completely consistent with an actual star trail picture, and since a screen is upward during shooting by the front camera, the user may conveniently preview the shooting effect in real time.

### BRIEF DESCRIPTION OF THE DRAWINGS

FIG. 1 is a flowchart of a first embodiment of a shooting method for a mobile terminal according to the disclosure;

FIG. 2 is a flowchart of a second embodiment of a shooting method for a mobile terminal according to the disclosure;

FIG. 3 is a flowchart of a third embodiment of a shooting method for a mobile terminal according to the disclosure;

FIG. 4 is a module diagram of a first embodiment of a mobile terminal according to the disclosure;

FIG. 5 is a module diagram of a second embodiment of a mobile terminal according to the disclosure; and

FIG. 6 is a module diagram of a third embodiment of a mobile terminal according to the disclosure.

Achievement of the purpose, function characteristics and advantages of the disclosure will be further described with reference to embodiments and the drawings.

### DETAILED DESCRIPTION

It should be understood that specific embodiments described here are only adopted to explain the disclosure and not intended to limit the disclosure.

A mobile terminal of the disclosure rather simulates long-time exposure by adopting an image synthesis technology than performs long-time exposure dependent on camera shooting hardware, performs long-time exposure by continuously acquiring image data of a shot object, regulates and limits a parameter such as an International Standards Organization (ISO), quality of a picture and a scene mode with reference to a requirement of a star trail shooting scene, outputs the parameter to hardware equipment and acquires the images to perform image synthesis to realize a star trail shooting function. However, the disclosure is not limited to shoot a star trail, and is also suitable for another similar scene of, for example, shooting a stream of vehicles on a highway into a strip-type luminous body at night.

Referring to FIG. 1, the disclosure discloses a first embodiment of a shooting method for a mobile terminal, and the shooting method includes the following steps.

Step 101: after shooting is started, a camera acquires images at preset time intervals, that is to say, the camera repeatedly acquires images every preset time period.

According to the disclosure, a star trail shooting mode is added to a shooting function of the mobile terminal, and a user may select the star trail shooting mode or an ordinary camera shooting mode for shooting, herein the star trail shooting mode presets a parameter such as exposure time, an ISO, a resolution, exposure compensation and a noise reduction parameter with reference to a requirement of a star trail shooting scene, and may also preset different parameters for the user to select during shooting according to different starry sky scenes over different regions.

When the user selects the star trail shooting mode and presses a shooting key or triggers a virtual shooting key, the mobile terminal starts star trail shooting and acquires the images by virtue of the camera, each preset time interval is equivalent to the exposure time, a star trail is shot continuously rather than at intervals, and each preset time interval is preferably 5 to 10 seconds. The acquired images may be cached in a caching module, an image synthesis module in a subsequent step reads the images from the caching module for synthesis, and the acquired images may also be directly sent to the image synthesis module in the subsequent step for synthesis.

During starry sky shooting, a focus may be automatically set to be infinitely far.

Step 102: image synthesis is performed according to luminance information of a current image and luminance information of a previous image, and a synthetic image is generated.

The image synthesis module of the mobile terminal directly receives the acquired images; or the images are read for image synthesis in real time from the caching module, and the caching module is reset to clear the data therein to provide a space for subsequent data. The image synthesis module performs image synthesis according to the luminance information of the current image and the luminance information of the previous image, and generates the synthetic image. The camera continuously acquires the images, and the synthetic image is also continuously generated in real time.

In a preferred embodiment, for pixels at the same region and different times, the image synthesis module determines whether luminance of the pixel in the current image is higher than luminance of the pixel in the previous image, replaces the pixel in the previous image with the pixel in the current image if YES, and obtains the final synthetic image after pixels with lower luminance in the previous image are all replaced. That is, a luminance selection manner is adopted for image synthesis in the embodiment, i.e. a synthesis method of taking a synthesized image (previous image) as a basic image and selecting pixels of which luminance is higher than that of pixels in the basic image in a subsequent image for replacement.

For example, a first image has been shot, then the first image (previous image) is taken as a basis, pixels of the first image and a second image at corresponding regions are compared when the second image (current image) is shot, the pixels of the first image are replaced with the pixels of the second image at the corresponding regions to finally obtain a synthetic image if luminance of the second image is higher than luminance of the first image, and the same processing is performed on a subsequent image to finally obtain a star trail chart by taking the synthetic image as a basis.

For another example, every image includes totally n pixel units, i.e. pixel unit 1, pixel unit 2 . . . pixel unit n, herein luminance of totally 200 pixel units from pixel unit 501 to pixel unit 700 in the current image is higher than that in the previous image, and the image synthesis module replaces pixels of pixel unit 501 to pixel unit 700 in the previous image with pixels of pixel unit 501 to pixel unit 700 in the current image to obtain a new image, i.e. the synthetic image. Compared with a bright point superposing manner, such a bright point replacement manner has the advantages that a motion trail of a star may be shot more clearly and influence of other excessively bright points beside the trail of the star on a star trail effect may be prevented.

In addition, the image synthesis module further performs noise reduction processing on the synthetic image, and also controls a synthesis proportion of a new synthetic image to inhibit over-exposure according to exposure of an existing image.

Step 103: the synthetic image is displayed in real time.

The mobile terminal displays the synthetic image on a display screen in real time for the user to preview a current star trail effect in real time. In order to achieve a smooth previewing effect, the synthetic image displayed by the mobile terminal is a compressed small-scale thumbnail, and the full-scale image is stored, that is, display and storage are implemented as two threads.

When the user presses the shooting key again or presses an end key, the shooting is ended. The mobile terminal may locally store each synthetic image, and may also only store the last synthetic image generated at the end of shooting.

Therefore, the star trail shooting function is added to the mobile terminal, the user may shoot the motion trail of the star and preview the shooting effect in real time by virtue of the mobile terminal, and the user experience is improved.

Referring to FIG. 2, the disclosure discloses a second embodiment of a shooting method for a mobile terminal, and the shooting method includes the following steps.

Step 201: upon reception of a shooting instruction, shooting is started after a preset time delay.

In order to avoid influence of slight shake generated when a shooting key is pressed on a shooting effect, an anti-shake function is realized by delayed shooting in the embodiment. That is, after a user presses the shooting key to send the shooting instruction, the mobile terminal does not perform shooting immediately, and instead, starts shooting when manmade shake is stopped after the preset time delay. The preset time delay is preferably 1 to 3 seconds.

Preferably, images are acquired at preset time intervals by virtue of a front camera.

During star trail shooting of the user, the camera is required to face the sky, and if a rear camera is utilized for shooting, a screen of the mobile terminal is downward and it is inconvenient for previewing of the user. In the embodiment, the front camera is utilized for shooting, the screen of the mobile terminal is upward, i.e., the screen of the mobile terminal faces the user's face, and then the user may conveniently check the shooting effect. Of course, the user may freely switch the front camera and the rear camera according to a requirement.

Step 203: mirroring processing is performed on the acquired images.

Since a star trail picture captured by the front camera forms a mirror relationship with an actual picture, mirroring processing is performed on the acquired images at first after the images are acquired in the embodiment, and then the processed images are sent to a caching module or directly sent to an image synthesis module for the image synthesis module to generate a synthetic image. In some embodiments, the mobile terminal may also query about whether the user is required to perform mirroring processing on the images and execute corresponding operation according to selection of the user.

Step 204: image synthesis is performed according to luminance information of a current image and luminance information of a previous image, and a synthetic image is generated.

Step 205: the synthetic image is displayed in real time.

Mirroring processing is performed on the acquired images in advance, and the synthetic image displayed at this moment is completely consistent with the actual star trail picture, so that the user is not required to perform mirroring processing. Since the screen faces the user's face, the user may conveniently preview the star trail shooting effect in a shooting process.

In some embodiments, when the front camera is utilized for shooting, mirroring processing may also be performed on the synthetic image after the synthetic image is generated, and then the processed synthetic image is displayed and stored in real time.

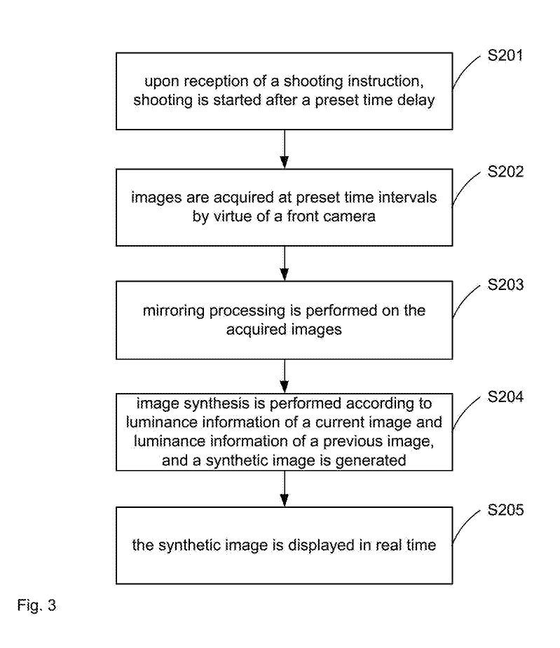

Referring to FIG. 3, the disclosure discloses a third embodiment of a shooting method for a mobile terminal, and the shooting method includes the following steps.

Step 301: image data of a shot object is continuously acquired through a camera.

Step 302: the image data is read at preset time intervals, and images are output.

An image synthesis module reads the image data once from a caching module at preset time intervals, and outputs the images according to the read image data.

Step 303: luminance information of the output images and luminance information of basic images are analysed and compared in real time, the output images and the basic images are synthesized according to analysis results, and synthetic images are generated.

Preferably, the image synthesis module determines whether luminance of a pixel in a current output image is higher than luminance of a pixel in a basic image at the same region, replaces the pixel in the basic image with the pixel in the current output image at the same region if YES, otherwise does not performs replacement, and accordingly performs image synthesis, herein the luminance of the pixel refers to the luminance of the colour of the pixel, and what is replaced is colour information of the pixel. Herein, a first output image is a basic image of first image synthesis and a new synthetic image is a basic image of next image synthesis.

Step 304: the synthetic images are displayed in real time.

The mobile terminal displays the synthetic images on a display screen in real time for a user to preview a current star trail effect in real time.

Optionally, when the camera acquiring the image data is a front camera, mirroring processing is further performed on the acquired image data, or mirroring processing is further performed on the synthetic images obtained by image synthesis.

Optionally, after the mobile terminal receives a shooting instruction, the mobile terminal does not perform shooting immediately, and instead, starts shooting after a preset time delay, thereby avoiding influence of slight shake generated when a shooting key is pressed on the shooting effect. The preset time delay is preferably 1 to 3 seconds.

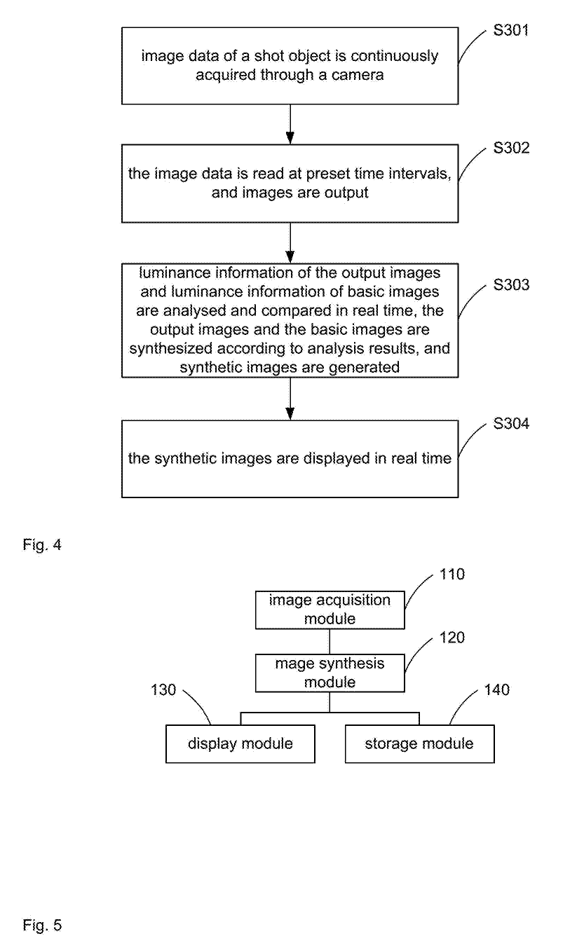

Referring to FIG. 4, the disclosure discloses a first embodiment of a mobile terminal, the mobile terminal may be an ordinary digital camera such as a pocket camera, and may also be terminal equipment with a shooting function such as a mobile terminal and a tablet, and the mobile terminal is a mobile terminal which implements star trail shooting, and includes an image acquisition module 110, an image synthesis module 120, a display module 130 and a storage module 140, herein the image acquisition module 110 and the image synthesis module 120 are sequentially connected, and the image synthesis module 120 is connected with the display module 130 and the storage module 140 respectively.

The image acquisition module 110: is configured to invoke a camera to acquire images.

According to the disclosure, a star trail shooting mode is added to a shooting function of the mobile terminal, and a user may select the star trail shooting mode or an ordinary camera shooting mode for shooting. When the user selects the star trail shooting mode and presses a shooting key or triggers a virtual shooting key, the mobile terminal starts star trail shooting, the image acquisition module 110 invokes the camera to acquire the images at preset time intervals, each preset time interval is equivalent to exposure time, a star trail is shot continuously rather than at intervals, and each preset time interval is preferably 5 to 10 seconds. During starry sky shooting, the image acquisition module 110 may automatically set a focus of the camera to be infinitely far.

The star trail shooting mode in the disclosure presets a parameter such as the exposure time, an ISO, a resolution, exposure compensation and a noise reduction parameter with reference to a requirement of a star trail shooting scene, and may also preset different parameters for the user to select during shooting according to different starry sky scenes over different regions. During shooting, the parameter is output to related hardware equipment such as the image acquisition module 110 to enable the hardware equipment to perform sample selection or pre-processing on the acquired images according to the set parameter.

Then the image acquisition module 110 sends the acquired images to the image synthesis module 120. In some embodiments, the mobile terminal may further include a caching module, the image acquisition module 110 stores the acquired images into the caching module, and the subsequent image synthesis module 120 directly reads image information from the caching module.

The image synthesis module 120: is configured to perform image synthesis according to luminance information of a current image and luminance information of a previous image, and generate a synthetic image. The camera continuously acquires the images, so that the synthetic image is also continuously generated.

In a preferred embodiment, for pixels at the same region and different times, the image synthesis module 120 determines whether luminance of the pixel in the current image is higher than luminance of the pixel in the previous image, replaces the pixel in the previous image with the pixel in the current image if YES, and obtains the final synthetic image after pixels with lower luminance in the previous image are all replaced. That is, a luminance selection manner is adopted for image synthesis in the embodiment, i.e. a synthesis method of taking a synthesized image (previous image) as a basic image and selecting pixels of which luminance is higher than that of pixels in the basic image in a subsequent image for replacement.

For example, a first image has been shot, then the first image (previous image) is taken as a basis, pixels of the first image and a second image at corresponding regions are compared when the second image (current image) is shot, the pixels of the first image are replaced with the pixels of the second image at the corresponding regions to finally obtain a synthetic image if luminance of the second image is higher than luminance of the first image, and the same processing is performed on a subsequent image to finally obtain a star trail chart by taking the synthetic image as a basis.

For another example, every image includes totally n pixel units, i.e. pixel unit 1, pixel unit 2 . . . pixel unit n, herein luminance of totally 200 pixel units from pixel unit 501 to pixel unit 700 in the current image is higher than that in the previous image, and the image synthesis module replaces pixels of pixel unit 501 to pixel unit 700 in the previous image with pixels of pixel unit 501 to pixel unit 700 in the current image to obtain a new image, i.e. the synthetic image. Compared with a bright point superposing manner, such a bright point replacement manner has the advantages that a motion trail of a star may be shot more clearly and influence of other excessively bright points beside the trail of the star on a star trail effect may be prevented.

The image synthesis module 120 sends the synthetic image to the display module 130 for display and to the storage module 140 for storage. The image synthesis module 120 may send each synthetic image to the storage module 140, and may also send the last synthetic image generated at the end of shooting to the storage module 140.

In order to achieve a smooth previewing effect, the image synthesis module 120 compresses the synthetic image into a small-scale thumbnail and sends the thumbnail to the display module 130 for display.

The display module 130: is configured to display the synthetic image in real time for the user to preview the current star trail effect in real time.

The storage module 140: is configured to store the synthetic image.

Therefore, the star trail shooting function is added to the mobile terminal, the user may shoot the motion trail of the star and preview the star trail effect in real time by virtue of the mobile terminal, and the user experience is improved.

In a second embodiment shown in FIG. 5, the mobile terminal further has an anti-shake function during star trail shooting. The difference between the embodiment of the first embodiment is that an anti-shake module 150 is added, the anti-shake module 150 is connected with the image acquisition module 110, and is configured to receive a shooting instruction, and after receiving the shooting instruction, transmit the shooting instruction to the image acquisition module 110 after a preset time delay, and the image acquisition module 110 starts acquiring the images after receiving the shooting instruction. That is, after the user presses the shooting key to send the shooting instruction, the mobile terminal does not perform shooting immediately, and instead, starts shooting when manmade shake is stopped after the preset time delay. The preset time delay is preferably 1 to 3 seconds.

Therefore, the anti-shake function is realized by delayed shooting to avoid influence of slight shake generated when the shooting key is pressed on a shooting effect and further improve a shooting experience of the user.

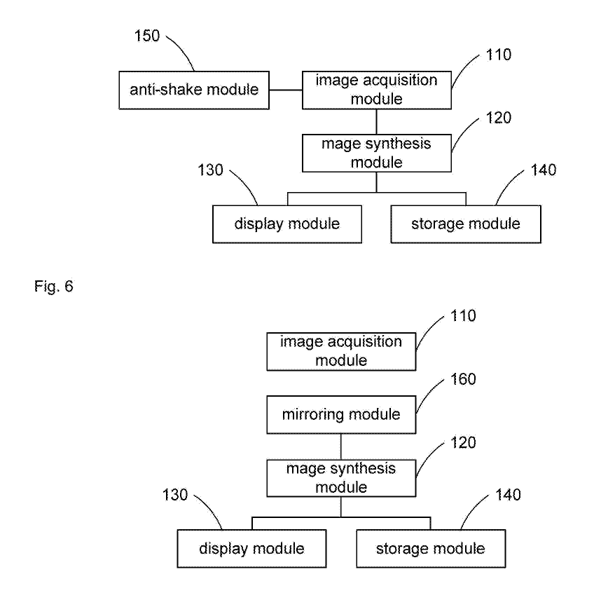

FIG. 6 shows a third embodiment of the mobile terminal of the disclosure, and the difference between the embodiment and the first embodiment is that a mirroring module 160 is added, herein the image acquisition module 110, the mirroring module 160 and the image synthesis module 120 are sequentially connected, and the mirroring module 160 is configured to: determine whether the currently used camera is a rear camera, perform mirroring processing on the acquired images if YES, transmit the processed images to the caching module image synthesis module 120, and if NO, not perform any processing and directly transmit the images to the image synthesis module 120.

During star trail shooting of the mobile terminal of the embodiment, the user is allowed to freely switch a front camera and the rear camera. Since a star trail picture captured by the front camera forms a mirror relationship with an actual picture, the mirroring module 160 is adopted to perform mirroring processing on the acquired images after the images are acquired by virtue of the front camera in the embodiment, then the processed images are sent to the caching module or directly sent to the image synthesis module 120 for the image synthesis module 120 to generate the synthetic image, and the synthetic image generated at this moment is completely consistent with the actual star trail picture. Therefore, the user is not required to perform mirroring processing. During star trail shooting of the user, the camera is required to face the sky, and if the rear camera is utilized for shooting, a screen of the mobile terminal is downward and it is inconvenient for previewing of the user. When the front camera is utilized for shooting, the screen of the mobile terminal is upward and the user may conveniently check the shooting effect.

In some embodiments, the mirroring module 160 may also be connected with the image synthesis module 120, the display module 130 and the storage module 140 respectively, and after determining that the currently used camera is the rear camera, performs mirroring processing on the synthetic image generated by the image synthesis module 120 and sends the processed synthetic image to the display module 130 and the storage module 140 for real-time display and storage respectively.

In some embodiments, the mirroring module 160 may further directly query about whether the user requires mirroring processing, and if YES, performs mirroring processing on the acquired images or the synthetic image.

The mobile terminal and its shooting method of the disclosure are applicable to other similar application scenes, besides star trail shooting.

Those skilled in the art should understand that all or part of the steps in the method embodiments may be implemented by related hardware controlled through a program, and the program may be stored in a computer-readable storage medium, the storage medium including a Read-Only Memory/Random Access Memory (ROM/RAM), a magnetic disk, a compact disc and the like.

The description made above with reference to the drawings is only the preferred embodiment of the disclosure and not intended to limit the scope of protection of the disclosure. Those skilled in the art may implement the disclosure with various transformed solutions without departing from the scope and substance of the disclosure, and for example, a characteristic of one embodiment may form another embodiment to obtain another embodiment. Any modifications, equivalent replacements and improvements made within the technical concept of the disclosure shall fall within the scope of protection of the disclosure.

### INDUSTRIAL APPLICABILITY

According to the shooting method for the mobile terminal provided by the disclosure, the images are acquired at preset time intervals, image synthesis is performed according to the luminance information of the current image and the luminance information of the previous image, and the synthetic image is generated, so that long-time exposure is simulated by adopting the image synthesis technology, long-time exposure is performed by continuously acquiring the image data of the shot object, the star trail shooting function is added to the mobile terminal, then the user may shoot the motion trail of the star or implement the similar application scene and preview the shooting effect in real time by virtue of the mobile terminal, the diversified requirement of the user is met, and the user experience is improved. In addition, the bright point replacement manner is preferably adopted for image synthesis in the embodiment, and compared with the bright point superposing manner, has the advantages that the motion trail of the star may be shot more clearly and the influence of the other excessively bright points beside the trail of the star on the star trail effect is prevented. The front camera of the mobile terminal may also be utilized for star trail shooting, mirroring processing is performed on the images to make the synthetic images completely consistent with an actual star trail picture, and since the screen is upward during shooting by the front camera, the user may conveniently preview the shooting effect in real time.

1. A shooting method for a mobile terminal, comprising the following steps:
acquiring, by a camera, images at preset time intervals;
determining whether luminance of a pixel in a current image is higher than luminance of a pixel in a previous image at a same region; and
if YES, replacing the pixel in the previous image with the pixel in the current image at the same region, accordingly performing image synthesis, and generating a synthetic image.

2. A shooting method for a mobile terminal, comprising the following steps:
acquiring, by a camera, images at preset time intervals; and
performing image synthesis according to luminance information of a current image and luminance information of a previous image, and generating a synthetic image.

3. The shooting method according to claim 2, wherein performing image synthesis according to the luminance information of the current image and the luminance information of the previous image comprises:
determining whether luminance of a pixel in the current image is higher than luminance of a pixel in the previous image at a same region; and
if YES, replacing the pixel in the previous image with the pixel in the current image at the same region, and accordingly performing image synthesis.

4. The shooting method according to claim 2, further comprising: after the step of generating the synthetic image, displaying the synthetic image in real time.

5. The shooting method according to claim 2, wherein the camera is a front camera, and wherein the method further comprises: after the step of acquiring, by the camera, the images at preset time intervals,
performing mirroring processing on the images.

6. The shooting method according to claim 2, wherein the camera is a front camera, and the method further comprises: after the step of generating the synthetic image, performing mirroring processing on the synthetic image.

7. The shooting method according to claim 2, further comprising: before the step of acquiring, by the camera, the images at preset time intervals,
upon reception of a shooting instruction, starting shooting after a preset time delay.

8-13. (canceled)

14. A shooting method for a mobile terminal, comprising the following steps:
continuously acquiring, by a camera, image data of a shot object;
reading the image data at preset time intervals, and outputting images; and
analysing and comparing luminance information of the output images and luminance information of basic images in real time, synthesizing the output images and the basic images according to analysis results, and generating synthetic images,
wherein a first output image is a basic image of first image synthesis, and a newly generated synthetic image is a basic image of next image synthesis.

15. The shooting method according to claim 14, wherein analysing and comparing the luminance information of the output images and the luminance information of the basic images in real time, synthesizing the output images and the basic images according to the analysis results and generating the synthetic images comprises:
determining whether luminance of a pixel in a current output image is higher than luminance of a pixel in a basic image at a same region; and
if YES, replacing the pixel in the basic image with the pixel in the current output image at the same region, and accordingly performing image synthesis.

16. The shooting method according to claim 14, further comprising: after the step of generating the synthetic images, displaying the synthetic images in real time.

17. The shooting method according to claim 14, wherein the camera is a front camera, and wherein the method further comprises: after the step of acquiring, by the camera, the image data,
performing mirroring processing on the acquired image data.

18. The shooting method according to claim 14, further comprising: before the step of acquiring, by the camera, the image data,
upon reception of a shooting instruction, starting shooting after a preset time delay.

19. A mobile terminal, comprising:
a processor; and
a memory for storing instructions executable by the processor,
wherein the processor is configured to execute the shooting method according to claim 1.

20. A mobile terminal, comprising:
a processor; and
a memory for storing instructions executable by the processor,
wherein the processor is configured to execute the shooting method according to claim 2.

21. A mobile terminal, comprising:
a processor; and
a memory for storing instructions executable by the processor,
wherein the processor is configured to execute the shooting method according to claim 14.

22. A non-transitory computer-readable storage medium having stored therein instructions that, when executed by a processor, causes the processor to perform the shooting method for a terminal according to claim 1.

23. A non-transitory computer-readable storage medium having stored therein instructions that, when executed by a processor, causes the processor to perform the shooting method for a terminal according to claim 2.

24. A non-transitory computer-readable storage medium having stored therein instructions that, when executed by a processor, causes the processor to perform the shooting method for a terminal according to claim 14.
